(19) United States
(12) Patent Application Publication
(10) Pub. No.: US 2025/0188236 A1
(43) Pub. Date: Jun. 12, 2025

(54) EPOXY RESIN COMPOSITIONS AND COMPOSITE MATERIALS THEREOF

(71) Applicant: Barrday Corporation, Millbury, MA (US)

(72) Inventor: Ryo Okada, Millbury, MA (US)

(73) Assignee: Barrday Corporation, Millbury, MA (US)

(21) Appl. No.: 18/974,004

(22) Filed: Dec. 9, 2024

Related U.S. Application Data
(60) Provisional application No. 63/607,894, filed on Dec. 8, 2023.

(51) Int. Cl. C08J 5/24; C08K 3/016

(52) U.S. Cl. CPC C08J 5/244; C08J 5/249; C08K 3/016; C08J 2363/00

(57) ABSTRACT

A halogen, antimony, phenolic-free thermosetting epoxy resin composition is provided. The halogen, antimony, phenolic-free epoxy resin composition comprises an epoxy resin, a curing agent, a catalyst and a fire-resistive additive. When the epoxy resin composition is impregnated into a fabric such as a fiberglass fabric and molded into a panel, the panel has an OSU two minute total heat release of less than 40 KW-min/m² and an OSU peak heat release rate of less than 40 kW/m². The epoxy resin composition can be combined with a fabric such as a fiberglass fabric to form a prepreg. The prepreg, when in contact with at least one honeycomb structure, can be cured to form composite materials including panels for use in aerospace interior applications.

### RELATED APPLICATION

The present application claims the benefit of U.S. Provisional Patent Application No. 63/607,894 entitled Epoxy Resin Compositions and Composite Materials Thereof filed on Dec. 8, 2023, the entire contents of which are hereby incorporated by reference in their entirety.

### TECHNICAL FIELD

The embodiments disclosed herein relate to epoxy resin compositions and composite materials thereof, and, in particular to epoxy resin compositions and composite materials that have a low heat release rate and low total heat release upon burning.

### BACKGROUND

The following paragraphs are not an admission that anything discussed in them is prior art or part of the knowledge of persons skilled in the art.

Composite materials may be used to create parts in a variety of industries, such as structural panels used in the interior of aircrafts. Fabrication of these structural panels typically involves the use of intermediate materials called thermoset prepregs, where structural fibers such as carbon, glass and aramid are impregnated within a thermoset resin, such as an epoxy or phenolic-based resin. Such intermediate materials that consist of fiber and resin can be molded into a rigid structure by adding heat and/or pressure.

Composite materials for aircraft interior applications must meet very stringent Flame, Smoke and Toxicity (FST) requirements in order to protect aircraft passengers in the case of an accident and/or fire. Typically, composites formed from phenolic-based resins have better FST properties compared to composites formed from epoxy resins, whereas composites formed from epoxy resins have better mechanical properties compared to composites formed from phenolic-based resins. Accordingly, it has become common practice for manufacturers of composite materials to maximize phenolic-based resin usage in composite materials intended for use in areas where lower mechanical properties are acceptable and maximize epoxy resin usage in composite materials intended for use in areas where higher mechanical properties are desired.

Fire Resistant (FR) additives can be added to phenolic- and epoxy resins to improve FST properties of resulting composite materials, but these additives are commonly toxic and can only be used in small amounts. Further, worldwide compliance standards (such as REACH, a regulation of the European Union, adopted to improve the protection of human health and the environment from the risks that can be posed by chemicals) have been phasing out use of potentially toxic chemicals in aircraft interior applications including the use of halogens and antimony compounds as FR additives. It is expected that the use of phenolic-based resins in aircraft interior applications will also be phased out in the near future.

Without effective FR additives and phenolic-based resins, the composite material manufacturing industry faces a major challenge in producing acceptable composite materials for aircraft interior applications that meet the current and expected compliance regulations.

### SUMMARY

A halogen, antimony, phenolic-free thermosetting epoxy resin composition is described herein. The halogen, antimony, phenolic-free epoxy resin composition comprises an epoxy resin, a curing agent, a catalyst and a fire-resistive additive. When the epoxy resin composition is impregnated into a fabric such as a fiberglass fabric and molded into a panel, the panel has an OSU two minute total heat release of less than 40 kW-min/m² and an OSU peak heat release rate of less than 40 kW/m².

According to some aspects of the epoxy resin composition, the epoxy resin may be a biphenyl-based epoxy resin, a naphthalene-based epoxy resin or an aralkyl-based epoxy resin. Additionally, an amount of the epoxy resin in the composition may be between 30 and 70 weight percent of total weight of the epoxy resin composition.

According to some aspects of the epoxy resin composition, an amount of the curing agent is between 3 and 10 weight percent of total weight of the epoxy resin composition.

According to some aspects of the epoxy resin composition, an amount of the catalyst is between 1 and 10 weight percent of the total weight of the epoxy resin composition.

According to some aspects of the epoxy resin composition, an amount of the fire-resistive additives is less than 40 weight percent of the total weight of the epoxy resin composition.

According to some aspects of the epoxy resin composition, the epoxy resin composition further comprises a toughener.

According to some aspects of the epoxy resin composition, the epoxy resin composition further comprises a non-reactive additive. Additionally, according to some aspects of the above, an amount of the non-reactive additive and the fire resistive additive is less than 40 weight percent of the total weight of the epoxy resin composition.

According to some aspects of the epoxy resin composition, when the epoxy resin composition is impregnated into a fabric such as a fiberglass fabric and molded into a panel, the panel has an OSU two minute total heat release of less than 35 KW-min/m² and an OSU peak heat release rate of less than 30 kW/m².

According to other aspects, the epoxy resin composition can be combined with a fabric such as a fiberglass fabric to form a prepreg. The prepreg, when in contact with at least one honeycomb structure, can be cured to form composite materials including panels for use in aerospace interior applications.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a flow chart of a method of producing an epoxy resin composition according to an example; and

FIG. 2 is a flow chart of a method of producing composite materials from an epoxy resin composition according to an example.

### DETAILED DESCRIPTION

Various apparatuses or processes will be described below to provide an example of each claimed embodiment. No embodiment described below limits any claimed embodiment and any claimed embodiment may cover processes or materials that differ from those described below. The claimed embodiments are not limited to materials or processes having all of the features of any one material or process described below or to features common to multiple or all of the materials described below. It is possible that a material or process described below is not covered by any of the claimed embodiments. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

Herein, the terms “epoxy-based resin” or “epoxy resin” refer to a compound having an epoxy group in its molecule, the term “epoxy-based resin composition” or more simply “epoxy composition” refers to an uncured composition containing an epoxy resin, a component for curing the epoxy resin (generally referred to as a “curing agent”, “curing catalyst”, or “curing accelerator”), and, optionally, one or more additives or modifiers (e.g. plasticizer, toughener, dye, organic pigment, inorganic filler, polymer compound, antioxidant, ultraviolet absorber, coupling agent, surfactant or other appropriate compound), and the term “epoxy-based resin composite” or “epoxy composite” refers to a cured product obtained by curing the epoxy resin composition.

### Epoxy Resin Composition

The epoxy resin compositions of the composite materials described herein comprise an epoxy resin. In some examples, the epoxy resin is a halogen, antimony, phenolic-free thermosetting epoxy resin that can be cured to a solid, infusible matrix surrounding reinforcing fibers in a composite material.

Typical examples of epoxy resins include non-halogen epoxy resins such as bisphenol A-based epoxy resins, bisphenol F-based epoxy resins, phenol novolac-based epoxy resins, cresol novolac-based epoxy resins, bisphenol A novolac-based epoxy resins, trifunctional phenol-based epoxy resins, tetrafunctional phenol-based epoxy resins, naphthalene-based epoxy resin, biphenyl-based epoxy resins, aralkyl-based epoxy resins, alicyclic epoxy resins, polyol-based epoxy resins, compounds obtained by epoxidizing a double bond, such as glycidylamines, glycidyl esters and butadiene, and compounds obtained by reacting hydroxyl-containing silicone resins with epichlorohydrin.

Of the aforementioned epoxy resins, naphthalene-containing epoxy resins, biphenyl-based epoxy resins, and aralkyl-based epoxy resins generally provide heat resistance and flame retardance when compared with other resins mentioned above

In the epoxy resin composition of the present embodiment, the content of the epoxy resin can be 10 to 90 weight percent, and particularly in the range of 30 to 70 weight percent, of the total epoxy resin composition. When the content of the epoxy resin is within the aforementioned ranges, the obtained composite materials demonstrate heat resistance and flame retardance.

The epoxy resin compositions of the composite materials described herein may further comprise a toughener. In some examples, the toughener of the epoxy resin compositions described herein may improve the toughness (e.g. fracture toughness, or the ability of a material containing a crack to resist fracture) of the composite material produced therefrom without impairing the mechanical properties. The toughener may also improve adhesion between the reinforcing fibers and the epoxy resin of the resulting composite materials without compromising heat resistance.

The toughener can include elastomers such as carboxyl-terminated butadiene-acrylonitrile (CTBN), amine-terminated butadiene acrylonitrile (ATBN), inorganic particles such as clay particles and carbon nanotubes, core-and-shell tougheners such as Kaneka Kane Ace, Block co-polymers such as Arkema Nanostrength, thermoplastic resin such as polypropylene, polybutyl terephthalate, ABS, polyamide, polyethylene terephthalate, polymethacrylate acid esters, polyvinyl acetal resins, polyacetal, polycarbonate, polyimide, polyphenylene oxide, polyether ketone, polysulfone, polyphenylene sulfide, polyamideimide, polyether sulfone, polyether ether ketone and polyether imide, and the like.

The epoxy resin composition of the composite materials described herein further comprises a curing agent. The term “curing agent” refers to polymerization promoters, co-curing agents, catalysts, initiators or other additives designed to participate in or promote curing of the thermosetting epoxy resin composition. With respect to epoxy containing thermosetting resin formulations, such curing agents include polymerization promoters and catalysts such as, for example, anhydrides, amines, imidazoles, amides, thiols, carboxylic acids, phenols, dicyandiamide, urea, hydrazine, hydrazide, amino-formaldehyde resins, melamine-formaldehyde resins, amine-boron trihalide complexes, quaternary ammonium salts, quaternary phosphonium salts, tri-aryl sulfonium salts, di-aryl iodonium salts, diazonium salts, and the like, as well as combinations of any two or more thereof, optionally also including a transition metal complex.

In one embodiment, the curing agent is a dicyandiamide hardener such as micronized dicyandiamide, dicyandiamide or cyanoguanidine (e.g. Dyhard® 100S, product of Alzchem or Omicure® DDA 10 of CVC Chemical).

In the epoxy resin composition of the present embodiment, the content of the curing agent may vary with the reactive functionality(ies) present, the presence of optional co-reactant(s), and the like. Typically, the quantity of curing agent will fall in the range of about 1 to 20 weight percent, and particularly in the range of 3 to 10 weight percent of the total epoxy resin composition.

The epoxy resin compositions of the composite materials described herein further comprise a catalyst. The catalyst in the resin composition is preferably, but not limited to, a hardening accelerator.

Examples of the catalyst used include, but not particularly limited to, substituted urea compounds, imidazole compounds; organometallic salts such as zinc naphthenate, cobalt naphthenate, tin octylate, cobalt octylate, bis(acetylacetonate) cobalt (II) and tris(acetylacetonate) cobalt (III); tertiary amines such as triethylamine, tributylamine and diazabicyclo[2,2,2]octane; phenol compounds such as phenol, bisphenol-A and nonylphenol; organic acids such as acetic acid, benzoic acid, salicylic acid and para-toluenesulfonic acid; and a mixture of these. Including their derivatives, these may be used alone or in combination of two or more as a hardening accelerator.

In the resin composition of the present embodiment, the content of the catalyst can be 1 to 50 weight percent, and particularly in the range of 1 to 10 weight percent, of the total resin composition. When the content of the epoxy resin is within the aforementioned ranges, the catalyst can increase the speed the curing process and decrease processing time during composite fabrication.

The epoxy resin compositions of the composite materials described herein further comprise one or more fire-resistive additives. The fire-resistive additives of the compositions described herein are halogen-free additives. In some examples, the fire-resistive additive is a phosphorus-based additive as phosphorus-based additives generally provide flame retardant properties to resulting composite materials.

Examples of non-halogenated fire-resistive additives include phosphorous compounds which includes inorganic phosphorus base compounds such as red phosphorus, ammonium phosphates and metal hypophosphates, semi-organic phosphorus compounds such as amine and melamine salts of phosphoric acids, metal salts of organophoshinic acids and phosphonium salts, and phosphate and phosphonate esters, mineral filler flame retardants such as aluminum tri-hydroxide, and magnesium hydroxide, zinc borate, zinc stannate, zinc hydroxyl stannate, molybdates, nitrogen-based FR compounds such as ammonia salts, melamine salts, melamine cyanurate, melamine phosphates, phosphazenes, phospham and phosphoroxynitrides, cyanuric acid-based compounds, silicone based flame retardants, and Boron based Flame retardants.

In the epoxy resin compositions described herein, the content of the fire-resistive additive may fall in the range of about 1 to 50 weight percent, and particularly in the range of 10 to 40 weight percent of the total epoxy resin composition.

The epoxy resin compositions as described herein may further comprise a rheology modifier. Examples of rheology modifiers include common adjuvants and additives such as but not limited to fumed silica.

The epoxy resin compositions as described herein may also comprise a solvent to provide for dissolution of one or more of the components in the resin composition. Examples of such a solvent include acetone, MEK, THF, DMF, Methanol, ethanol, and glycol ethers.

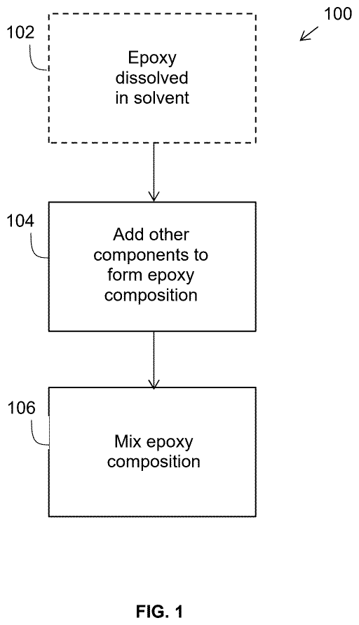

Referring to FIG. 1, illustrated therein is a method 100 for producing an epoxy composition, in accordance with one example. The method 100 provides an epoxy composition for use in the production of molded parts of composite materials that may be used in different structural applications. For example, some structural applications may include aircraft structural panels or recreation materials.

In one embodiment of method 100, at step 102 an epoxy (as previously described) may be dissolved in a solvent (also as previously described). It should be noted that step 102 is an optional step as the resin can also be formulated without a solvent (e.g. as a solvent-less hotmelt epoxy system).

At step 104, the other components are added to the epoxy to form an epoxy composition. The other components can include but are not limited to one or more curing agents; catalysts; fire-resistive additives, tougheners, rheology modifiers or other non-reactive compounds.

At step 106, the composition is mixed at a temperature and for a duration sufficient to distribute the components within the epoxy composition.

In an alternate embodiment, the epoxy resin may be part of a non-solvated “hot melt” system. In this embodiment, the epoxy resin may be melted by adding heat to the epoxy resin and then the addition components, such as but not limited to can be added to the melted epoxy resin and the resulting composition can be mixed to form a generally homogenous epoxy composition.

### Composite Materials

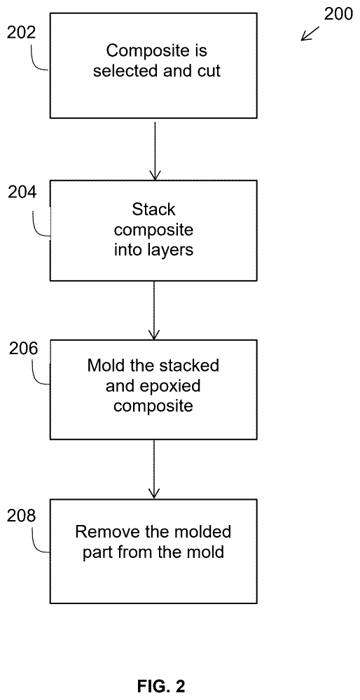

Referring to FIG. 2, illustrated herein is a method 200 for producing a composite material, in accordance with one example. The method 200 creates a molded part of composite material that may be used in different structural applications. For example, some structural applications may include aircraft structural panels or recreational materials.

At 202, long fiber thermoset reinforcement composites are selected, cut, and stacked (at 204) into one or more layers. The fibers are long in that they are generally continuous along the length and/or width of the layer, or at least a significant portion of the length and/or width of the layer. The long fibers are not chopped fibers or SMC. Short fiber composites or SMC have a higher resin content allowing internal mold release agents to migrate more easily.

In some examples, the long fiber thermoset reinforcement composite may include an intermediate material called prepreg (pre-impregnated). The prepreg includes a high performance fiber that is pre-impregnated with a bulk resin. The bulk resin could be an uncured thermoset resin, such as epoxy. The prepreg could include fibers, either in straight tape (unidirectional) or in woven form. The fibers may be, for example, carbon, glass, Kevlar, or any other high performance fiber with desirable properties for the application.

In some examples, fibers could be high-performance fibers such as aramid fibers, extended chain polyethylene fibers, and/or poly(p-phenylene-2,6-benzobisoxazole) (PBO) fibers. Other example fibers could include aramid and copolymer aramid fibers, for example as produced commercially by DuPont (Kevlar®), Teijin (Twaron®), Kolon (Heracron®), and Hyosung Aramid, modified para-aramids (e.g. Rusar®, Autex®), ultra high molecular weight polyethylene (UHMWPE) produced commercially by Honeywell, DSM, and Mitsui under the trade names Spectra®, Dyneema®, and Tekmilon®, respectively (as well as Pegasus® yarn), poly(p-phenylene-2,6-benzobisoxa-zole) (PBO) (produced by Toyobo under the commercial name Zylon®), and/or polyester-polyarylate yarns (e.g. Liquid crystal polymers produced by Kuraray under the trade name Vectran®).

The amount of strength provided by the fibers will depend upon the amount and the particular type of reinforcing fibers utilized as well as the orientation of the fibers in relationship to the stress that the composite material will be exposed to. The reinforcing fibers can be used in amounts ranging from about 20 weight percent to about 80 weight percent based on the total weight of the reinforcing fibers and epoxy resin composition. Where weight is a prime concern, the reinforcing fibers will be used in an amount that preferably falls near the lower end of the range disclosed. When strength is a prime concern rather than weight, the amount of reinforcing fibers used will generally fall in the upper end of the disclosed range.

At 206, the stacked prepreg and is placed in to a mold to create a molded part. The mold applies heat and/or pressure for an appropriate amount of time to cure the resin in the composite material. The resin may cure through processes such as autoclave, compression molding, vacuum bag, and oven etc. Generally, the surface film is compatible to the bulk resin of the composite and may cure in the same way, or in a similar manner. At 208, the cured composite, molded part is removed from the mold.

### FST Properties of Composite Materials

There are several properties which can be used to measure the FST properties of composite materials. Such properties include vertical burn, heat release, smoke density and smoke toxicity. In particular, the heat release property is a challenging value to meet. Composites suitable for aerospace interior application generally have their heat release properties measured using an apparatus developed by Ohio State University (OSU). This test is often referred to as the OSU heat release test. A typical fire-resistive grade epoxy prepreg specification is set at maximum of 65 KW/m² peak and 65 KW min/m² total, while fire-resistive grade phenolic prepreg specification is set at maximum of 30-45 KW/m² peak and 30-45 KW min/m².

The composite materials formed using the epoxy resin compositions described herein and reinforcing fibers meets the Ohio State University (OSU) heat release value of 40 KW/m² peak or lower, and 40 KW min/m² total or lower while keeping the non-reactive additive ratio below 40%.

### EXAMPLES

A prepreg impregnated by an epoxy resin composition, the epoxy resin comprising a naphthalene-based epoxy resin, a curing agent, a catalyst and a phosphorus-based additive, was formed and test samples were fabricated by combining 3pcf phenolic resin coated aramid honeycomb core with 1 layer of prepreg sheets on both sides, and cured in a press. The base reinforcement fabric used was style-7781 fiberglass fabric with a resin content of 40%.

The formulation of the components of the resin composition is provided in Table 1.

TABLE 1
Example epoxy resin composition.

| Chemical | Manufacturer | wt % |
|---|---|---|
| Acetone | | 17.5 |
| HP6000 epoxy resin | DIC | 52 |
| Dyhard 100S Curing agent | Alzchem | 5 |
| Curezol 2MZ-A catalyst | Air Product | 2.5 |
| Exolit AP422 FR Additive | Clariant | 23 |

These composites were produced by having a honeycomb core sandwiched with one or more layers of prepreg on both sides. The composites were then molded in a press.

Curing of the resin composition into composite materials was performed at 130° C. for 40 min at 90 psi. FST properties of composites cured according to the formulation of Table 1 are provided in Table 2, below.

A heat calorimetry testing methodology developed at Ohio State University, known as the OSU Flammability Test, was used to determine whether the polymer compositions met U.S. government air worthiness standards. The OSU tests measure the two minute total heat release (“2 min THR”) and the peak heat release rate (“Maximum HRR”), expressed in kilowatt times minutes per square meter of surface area (kW-min/m²) and kilowatt per square meter of surface area (kW/m²) respectively, for the first five minutes of a burn test under the conditions of the OSU testing. More precisely, the heat release properties of the polymer compositions were evaluated in accordance with FAR 25. 853 Amendment 25-83, Appendix F, Part IV. The samples were mounted vertically in an enclosed chamber and exposed to flame by multiple pilots mounted at the top and bottom of the sample fixture. The samples were simultaneously exposed to a radiant heat flux of 3.5 W/cm² and 85 ft³/min airflow. The heat released during combustion was determined by measuring the difference in temperature of the effluent air from the inlet air.

TABLE 2
FST Properties of Composites produced using
the epoxy resin composition of Table 1.

| FST properties | Results | Test method |
|---|---|---|
| OSU heat release peak | 27 | FAR 25.853 (d) |
| (KW/m²) | | |
| OSU heat release total (KW | 32 | FAR 25.853 (d) |
| min/m²) | | |

The data illustrate that the composites formed from the epoxy resin composition of Table 1 exhibit lower levels of heat release rate and total heat release when compared to industry standards.

While the above description provides examples of one or more apparatus, methods, or systems, it will be appreciated that other apparatus, methods, or systems may be within the scope of the claims as interpreted by one of skill in the art.

What is claimed is:

1. A halogen, antimony, phenolic-free thermosetting epoxy resin composition comprising:
a) an epoxy resin;
b) a curing agent;
c) a catalyst; and
d) a fire-resistive additive;
e) wherein, when the epoxy resin composition is impregnated into a fabric such as a fiberglass fabric and molded into a panel, the panel has an OSU two minute total heat release of less than 40 KW-min/m² and an OSU peak heat release rate of less than 40 kW/m².

2. The epoxy resin composition of claim 1, wherein the epoxy resin is a biphenyl-based epoxy resin.

3. The epoxy resin composition of claim 2, wherein the epoxy resin is a naphthalene-based epoxy resin.

4. The epoxy resin composition of claim 1, wherein the epoxy resin is an aralkyl-based epoxy resin.

5. The epoxy resin composition of claim 1, wherein an amount of the epoxy resin is between 30 and 70 weight percent of total weight of the epoxy resin composition.

6. The epoxy resin composition of claim 1, wherein an amount of the curing agent is between 3 and 10 weight percent of total weight of the epoxy resin composition.

7. The epoxy resin composition of claim 1, wherein an amount of the catalyst is between 1 and 10 weight percent of the total weight of the epoxy resin composition.

8. The epoxy resin composition of claim 1, wherein an amount of the fire-resistive additives is less than 40 weight percent of the total weight of the epoxy resin composition.

9. The epoxy resin composition of claim 1, further comprising a toughener.

10. The epoxy resin composition of claim 1, further comprising a non-reactive additive.

11. The epoxy resin composition of claim 9, wherein an amount of the non-reactive additive and the fire resistive additive is less than 40 weight percent of the total weight of the epoxy resin composition.

12. The epoxy resin composition of claim 1, wherein the panel has an OSU two minute total heat release of less than 35 KW-min/m² and an OSU peak heat release rate of less than 30 kW/m².

13. A prepreg comprising a fabric such as a fiberglass fabric impregnated with a halogen, antimony, phenolic-free thermosetting epoxy resin composition, the epoxy resin composition comprising:
a) an epoxy resin;
b) a curing agent;
c) a catalyst; and
d) a fire-resistive additive;
e) wherein, when the prepreg is molded into a panel, the panel has an OSU two minute total heat release of less than 40 kW-min/m² and an OSU peak heat release rate of less than 40 kW/m².

14. The prepreg of claim 13, wherein the panel has an OSU two minute total heat release of less than 35 KW-min/m² and an OSU peak heat release rate of less than 30 kW/m².

15. A composite material comprising a prepreg in contact with at least one honeycomb structure, the prepreg comprising a fabric such as a fiberglass fabric impregnated with a halogen, antimony, phenolic-free thermosetting epoxy resin composition, the epoxy resin composition comprising:
a) an epoxy resin;
b) a curing agent;
c) a catalyst; and
d) a fire-resistive additive;
e) wherein, when the composite material is molded into a panel, the panel has an OSU two minute total heat release of less than 40 KW-min/m² and an OSU peak heat release rate of less than 40 kW/m².

16. The composite material of claim 15, wherein the panel has an OSU two minute total heat release of less than 35 KW-min/m² and an OSU peak heat release rate of less than 30 kW/m².
